(19) United States
(12) Patent Application Publication
(10) Pub. No.: US 2023/0395840 A1
(43) Pub. Date: Dec. 7, 2023

(54) MANUFACTURING METHOD FOR SOLID-STATE BATTERY AND MANUFACTURING APPARATUS FOR SOLID-STATE BATTERY

(71) Applicant: HONDA MOTOR CO., LTD., Tokyo (JP)

(72) Inventors: Satonori IURA, Saitama (JP); Masaki KUNIGAMI, Saitama (JP); Yui KINOSHITA, Saitama (JP); Shuga IKEDA, Saitama (JP)

(21) Appl. No.: 18/060,571

(22) Filed: Dec. 1, 2022

(30) Foreign Application Priority Data
Dec. 9, 2021 (JP) 2021-199824

(51) Int. Cl. H01M 10/04

(52) U.S. Cl. CPC H01M 10/0468

(57) ABSTRACT

Provided is a manufacturing method for a solid-state battery capable of achieving densification, improvement of productivity, and preferred battery characteristics in a compatible manner. Embodiments provide a manufacturing method for a solid-state battery including an electrode layer composed of a positive electrode layer and a negative electrode layer, and a solid electrolyte layer, the method including: a first pressing step of pressing a layer including at least the solid electrolyte layer; a irregularity forming step of forming irregularities on a surface of the solid electrolyte layer; and a second pressing step of pressing the solid electrolyte layer and the electrode layer to thereby produce a laminate.

This application is based on and claims the benefit of priority from Japanese Patent Application No. 2021-199824, filed on 9 Dec. 2021, the content of which is incorporated herein by reference.

### BACKGROUND OF THE INVENTION

### Field of the Invention

The present invention relates to a manufacturing method for a solid-state battery and a manufacturing apparatus for a solid-state battery.

### Related Art

In the related art, secondary batteries such as lithium-ion secondary batteries having high energy density have been widely used. In recent years, from the viewpoints of improvement of energy efficiency, reduction of adverse effects on the global environment due to an increase in the proportion of renewable energy, and reduction of CO₂, the use of secondary batteries in various applications such as in-vehicle use is being studied. A secondary battery has a structure in which a solid electrolyte (separator) is provided between a positive electrode and a negative electrode and is filled with a liquid or solid electrolyte (electrolytic solution).

A solid-state battery including the solid electrolyte provides a higher degree of safety against heat than a secondary battery including an electrolytic solution, and can meet the demand for size reduction. On the other hand, the solid-state battery is required to have sufficiently high adhesion between an electrode layer and a solid electrolyte layer. For this reason, there is known a technique for improving the adhesion between the electrode layer and the solid electrolyte layer by forming irregularities (projections and depressions) on surfaces of the electrode layer and the solid electrolyte layer (for example, see Japanese Unexamined Patent Application, Publication No. 2017-103253).

Patent Document 1: Japanese Unexamined Patent Application, Publication No.2017-103253

### SUMMARY OF THE INVENTION

The electrode layer and the solid electrolyte layer in the solid-state secondary battery are preferably pre-pressed and then integrally pressed for the purpose of densification and productivity improvement. However, when the electrode layer and the solid electrolyte layer, which are pre-pressed, are integrally pressed, sufficient adhesion may not be obtained at the interface between the layers, and delamination may occur during a manufacturing process. In addition, even when the delamination does not occur, insufficient adhesion at the interface can cause disadvantages such as an increase in interface resistance, an increase in the risk of Li deposition, and deterioration of capacity rate characteristics. These disadvantages prevent preferred battery characteristics from being obtained. The technique disclosed in Japanese Unexamined Patent Application, Publication No. 2017-103253 does not form irregularities on the surfaces of the electrode layer and the solid electrolyte layer after densification pressing. Therefore, there is a demand for a technique capable of achieving densification, improvement of productivity, and improvement of adhesion in a compatible manner.

The present invention has been made in view of the above disadvantages, and is to provide a manufacturing method for a solid-state battery capable of achieving densification, improvement of productivity, and preferred battery characteristics in a compatible manner.

(1) An aspect of the present invention is directed to a manufacturing method for a solid-state battery including an electrode layer composed of a positive electrode layer and a negative electrode layer, and a solid electrolyte layer. The method includes: a first pressing step of pressing a layer including at least the solid electrolyte layer; an irregularity forming step of forming irregularities on a surface of the solid electrolyte layer; and a second pressing step of pressing the solid electrolyte layer and the electrode layer to thereby produce a laminate.

According to aspect (1) of the invention, it is possible to provide the manufacturing method for a solid-state battery capable of achieving densification, improvement of productivity, and preferred battery characteristics in a compatible manner.

(2) An aspect of the present invention provides a manufacturing method for a solid-state battery including an electrode layer composed of a positive electrode layer and a negative electrode layer, and a solid electrolyte layer. The method includes: a densification/irregularity-forming pressing step of pressing a layer including at least the solid electrolyte layer and forming irregularities on a surface of the solid electrolyte layer; and a second pressing step of pressing the solid electrolyte layer and the electrode layer to thereby produce a laminate.

According to aspect (2) of the invention, the formation of the irregularities for densification and improvement of adhesion can be achieved in one step. This feature makes it possible to simplify the manufacturing method for a solid-state battery capable of achieving densification, improvement of productivity, and preferred battery characteristics in a compatible manner.

(3) In the manufacturing method for a solid-state battery according to aspect (1) or (2), the forming of the irregularities on the surface of the solid electrolyte layer is performed by a press machine having projections on a contact portion that comes into contact with the solid electrolyte layer and configured to form the irregularities on the surface of the solid electrolyte layer using the projections of the contact portion.

According to aspect (3) of the invention, since the process can be continuously performed by the press machine, productivity of the solid-state battery can be further improved.

(4) In the manufacturing method for a solid-state battery according to aspect (3), the contact portion of the press machine is a sheet-like body having a surface with projections formed thereon, and the sheet-like body is used by being wound around a cylindrical body.

According to aspect (4) of the invention, it is possible to easily configure the press machine having the irregularities.

(5) In the manufacturing method for a solid-state battery according to aspect (4), the sheet-like body is detachably provided on the cylindrical body.

According to aspect (5) of the invention, the part of the press machine having the irregularities can be easily replaced, and ease of maintenance of the press machine can be improved.

(6) In the manufacturing method for a solid-state battery according to aspect (4) or (5), the sheet-like body is sandpaper.

According to aspect (6) of the invention, it is possible to easily and inexpensively configure the press machine having the irregularities.

(7) In the manufacturing method for a solid-state battery according to any one of aspects (4) to (6), the cylindrical body is a zirconia tube.

According to aspect (7) of the invention, the irregularities can be suitably formed on the surface of the solid electrolyte layer.

(8) In the manufacturing method for a solid-state battery according to aspect (3), the forming of the irregularities on the surface of the solid electrolyte layer includes continuously forming the irregularities by a roll having a surface with irregularities.

According to aspect (8) of the invention, productivity of the solid-state battery can be further improved.

(9) In the manufacturing method for a solid-state battery according to aspect (3), the forming of the irregularities on the surface of the solid electrolyte layer includes continuously forming the irregularities in multiple stages by a plurality of rolls having surfaces with irregularities.

According to aspect (9) of the invention, productivity of the solid-state battery can be further improved.

(10) In the manufacturing method for a solid-state battery according to aspect (1) or (2), the solid electrolyte layer includes a first region having a predetermined thickness inward from the surface of the solid electrolyte layer and a second region located further inside the solid electrolyte layer than the first region, and the forming of the irregularities on the surface of the solid electrolyte layer includes forming the irregularities only in the first region.

According to aspect (10) of the invention, the solid electrolyte layer can be densified, and adhesion between the solid electrolyte layer and the electrode layer can be improved.

(11) An aspect of the present invention provides a manufacturing apparatus for a solid-state battery including an electrode layer composed of a positive electrode layer and a negative electrode layer, and a solid electrolyte layer, the apparatus including: a first presser configured to press a layer including at least the solid electrolyte layer; an irregularity former configured to form irregularities on a surface of the solid electrolyte layer; and a second presser configured to press the solid electrolyte layer and the electrode layer to thereby produce a laminate.

According to aspect (11) of the invention, it is possible to provide the manufacturing apparatus for a solid-state battery capable of achieving densification, improvement of productivity, and preferred battery characteristics in a compatible manner.

(12) An aspect of the present invention provides a manufacturing apparatus for a solid-state battery including an electrode layer composed of a positive electrode layer and a negative electrode layer, and a solid electrolyte layer, the apparatus including: a densification/irregularity-forming presser configured to press a layer including at least the solid electrolyte layer and form irregularities on a surface of the solid electrolyte layer; and a second presser configured to press the solid electrolyte layer and the electrode layer to thereby produce a laminate.

According to aspect (12) of the invention, the formation of the irregularities for densification and improvement of adhesion can be performed by one presser. This feature makes it possible to simplify the manufacturing apparatus for a solid-state battery capable of achieving densification, improvement of productivity, and preferred battery characteristics in a compatible manner.

(13) In the manufacturing apparatus for a solid-state battery according to aspect (11) or (12), the irregularity former configured to form the irregularities on the surface of the solid electrolyte layer is a former configured to continuously form the irregularities using a cylindrical body having sandpaper wound therearound.

According to aspect (13) of the invention, it is possible to easily and inexpensively configure the irregularity former configured to form the irregularities on the surface of the solid electrolyte layer.

(14) In the manufacturing apparatus for a solid-state battery according to aspect (11) or (12), the irregularity former configured to form the irregularities on the surface of the solid electrolyte layer is a former configured to continuously form the irregularities using a metal roll having a surface subjected to sandblasting.

According to aspect (14) of the invention, productivity of the solid-state battery can be improved.

(15) In the manufacturing apparatus for a solid-state battery according to aspect (11) or (12), the irregularity former configured to form the irregularities on the surface of the solid electrolyte layer is a former configured to continuously form the irregularities using rolls disposed in multiple stages, the rolls having surfaces with irregularities.

According to aspect (15) of the invention, the productivity of the solid-state battery can be further improved.

(16) In the manufacturing apparatus for a solid-state battery according to aspect (11) or (12), the irregularity former configured to form the irregularities on the surface of the solid electrolyte layer forms projections on the surface of the solid electrolyte layer, and the second presser is configured to press the solid electrolyte layer and the electrode layer while crushing the projections to thereby produce a laminate.

According to aspect (16) of the invention, the adhesion between the solid electrolyte layer and the electrode layer can be improved.

### BRIEF DESCRIPTION OF THE DRAWINGS

FIG. 1 is a cross-sectional view showing a structure of a solid-state battery according to an embodiment of the present invention;

FIG. 2 is a schematic diagram showing a manufacturing apparatus for a solid-state battery according to an embodiment of the present invention;

FIG. 3 is a diagram showing an irregularity former of the manufacturing apparatus for a solid-state battery;

FIG. 4 is a microphotograph of a cross section of a solid electrolyte layer according to Comparative Example of the present invention;

FIG. 5 is a microphotograph of a cross section of a solid electrolyte layer according to Comparative Example of the present invention; and

FIG. 6 is a microphotograph of a cross section of a solid electrolyte layer according to Example of the present invention.

### DETAILED DESCRIPTION OF THE INVENTION

### First Embodiment

Hereinafter, a manufacturing method and a manufacturing apparatus for a solid-state battery according to a first embodiment of the present invention will be described. The manufacturing method and the manufacturing apparatus according to the present embodiment are for manufacturing a solid-state battery 1 including an electrode layer composed of a positive electrode layer and a negative electrode layer, and a solid electrolyte layer.

### Solid-State Battery

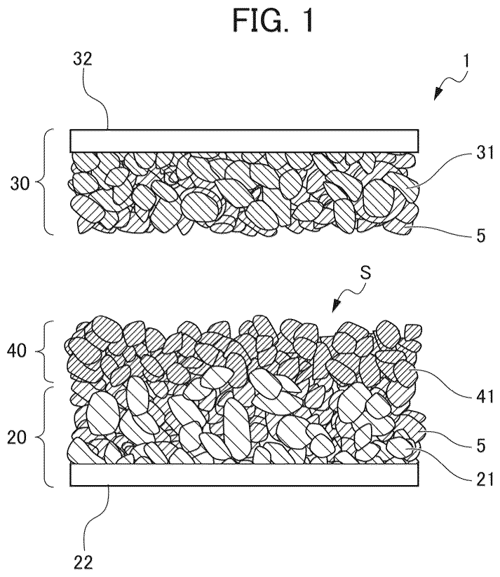

As shown in FIG. 1, the solid-state battery 1 manufactured by the manufacturing method for a solid-state battery according to the present embodiment includes a negative electrode layer 20 as an electrode layer, a solid electrolyte layer 40, and a positive electrode layer 30 as an electrode layer that are laminated in this order.

The negative electrode layer 20 includes, for example, a negative electrode current collector 22 and a layer containing a negative electrode active material 21 and formed on the negative electrode current collector 22. The layer containing the negative electrode active material 21 may contain a solid electrolyte 5, a binder, and a conductive additive in addition to the negative electrode active material 21. The solid electrolyte 5, the binder, and the conductive additive are not particularly limited, and materials known as electrode materials for solid-state batteries can be used as them.

The negative electrode active material 21 is not particularly limited, and materials known as negative electrode active materials for solid-state batteries can be used as it. Examples of the negative electrode active material 21 include lithium transition metal oxides such as lithium titanate (Li₄Ti₅O₁₂), transition metal oxide such as TiO₂, Nb₂O₃, and WO₃, metal sulfides, metal nitrides, graphite, carbon materials such as soft carbon and hard carbon, metallic lithium, metallic indium, and lithium alloys.

The negative electrode current collector 22 is not particularly limited, and materials known as negative electrode current collector for solid-state secondary batteries can be used as it. Examples of the negative electrode current collector 22 include copper, stainless steel, etc. The copper, stainless steel, etc. are used in the form of foil, for example.

The solid electrolyte layer 40 is a layer containing a solid electrolyte 41 as an essential component. The solid electrolyte 41 is not particularly limited as long as being a material capable of conducting lithium ions, and materials known as a solid electrolyte for solid-state secondary batteries can be used as it. Examples of the solid electrolyte 41 may include a sulfide-based solid electrolyte, an oxide-based solid electrolyte, a nitride-based solid electrolyte, and a halide-based solid electrolyte. The solid electrolyte layer 40 may contain, for example, a binder in addition to the solid electrolyte 41.

The positive electrode layer 30 includes, for example, a positive electrode current collector 32 and a layer containing a positive electrode active material 31 and formed on the positive electrode current collector 32. The layer containing the positive electrode active material 31 may contain a solid electrolyte 5, a binder, and a conductive additive in addition to the positive electrode active material 31. The solid electrolyte 5, the binder, and the conductive additive are not particularly limited, and materials known as electrode materials for solid-state batteries can be used as them.

The positive electrode active material 31 is not particularly limited, and materials known as positive electrode active materials for solid-state batteries can be used as it. Examples of the positive electrode active material 31 include layer-like positive electrode active material particles such as LiCoO₂, LiNiO₂, LiCo_{1/3}Ni_{1/3}Mn_{1/3}O₂, LiVO₂, and LiCrO₂, spinel-type positive electrode active materials such as LiMn₂O₄, Li(Ni_{0.25}Mn_{0.75})₂O₄, LiCoMnO₄, and Li₂NiMn₃O₈, and olivine-type positive electrode active materials such as LiCoPO₄, LiMnPO₄, and LiFePO₄.

The positive electrode current collector 32 is not particularly limited, and materials known as positive electrode current collector for solid-state batteries can be used as it. Examples of the positive electrode current collector 32 include aluminum, stainless steel, etc. The aluminum, stainless steel, etc. are used in the form of foil, for example. In addition to the above, a conductive carbon sheet (for example, a graphite sheet or a CNT sheet) may be used.

### Manufacturing Method for Solid-State Battery

A manufacturing method for a solid-state battery according to the present embodiment includes a first pressing step, an irregularity forming step, and a second pressing step of pressing a solid electrolyte layer and an electrode layer to thereby produce a laminate. In addition to the above, the manufacturing method for a solid-state battery according to the present embodiment includes an electrode layer forming step and a solid electrolyte layer forming step. FIG. 1 shows a state in which the negative electrode layer 20 and the solid electrolyte layer 40 have been integrated with each other in the first pressing step and the irregularities have been formed on a surface S of the solid electrolyte layer 40 in the irregularity forming step which will be described below, and in which the integrated negative electrode layer 20, solid electrolyte layer 40, and positive electrode layer 30 are to be pressed in the second pressing step.

### Electrode Layer Forming Step

A known solid-state battery electrode forming method can be applied to the electrode layer forming step of forming the negative electrode layer 20 and the positive electrode layer 30 as electrode layers. For example, either a wet method or a dry method may be used. To form the negative electrode layer 20 and the positive electrode layer 30 by the wet method, a method can be employed in which an electrode mixture slurry containing electrode active materials is applied to a current collector by, for example, a known doctor blade method and then is dried.

### Solid Electrolyte Layer Forming Step

A known solid electrolyte layer forming method can be employed in the solid electrolyte layer forming step of forming the solid electrolyte layer 40. For example, a sheet-like solid electrolyte layer may be formed by pressing a solid electrolyte. Alternatively, a process may be employed in which a solid electrolyte paste prepared by dispersing a solid electrolyte in a solvent is applied to a surface of the electrode.

### First Pressing Step

The first pressing step is a step of pressing a layer including at least the solid electrolyte layer 40. In the first pressing step, the layer including at least the solid electrolyte layer 40 is densified by being pressed in advance (before the second pressing step). It is preferable that the first pressing step makes the solid electrolyte layer 40 have dynamic hardness of 20 or more, as will be described later. The first pressing step is, for example, a step of pressing the solid electrolyte layer 40 and one of the negative electrode layer 20 and the positive electrode layer 30 to achieve densification and integration. The first pressing step may be, for example, a step of pressing the solid electrolyte layer 40 formed by applying the solid electrolyte paste to the negative electrode layer 20 or the positive electrode layer 30, together with the negative electrode layer 20 or the positive electrode layer 30, or a step of pressing the sheet-like solid electrolyte layer 40 together with the negative electrode layer 20 or the positive electrode layer 30. Alternatively, the first pressing step may be a step of pressing only the sheet-like solid electrolyte layer 40. Preferably, the electrode layer that is not pressed before the second pressing step is separately pressed in the first pressing step before the second pressing step.

Specific methods of pressing in the first pressing step are not particularly limited, and may include uniaxial pressing and roll pressing, for example. Pressing conditions can be set to, for example, 25° C. and 6 ton/cm² to 10 ton/cm².

### Irregularity Forming Step

The irregularity forming step is a step of forming irregularities (projections and depressions) on the surface, which is the laminated surface, of the solid electrolyte layer 40. The solid electrolyte layer 40 is densified but the surface thereof is smoothened in the first pressing step, and thus interfacial adhesion is reduced. The irregularity forming step is a step of improving the reduced interfacial adhesion of the solid electrolyte layer 40.

In a case where the solid electrolyte layer 40 and one of the negative electrode layer 20 and the positive electrode layer 30 are integrated with each other by the pressing in the first pressing step, irregularities are formed on one exposed side of the laminated surface of the solid electrolyte layer 40 in the irregularity forming step. In a case where only the sheet-like solid electrolyte layer 40 is pressed in the first pressing step, irregularities are formed on both sides of the laminated surface of the sheet-like solid electrolyte layer 40 in the irregularity forming step.

The irregularity forming step is a step of forming irregularities only in a first region having a predetermined thickness inward from the surface of the solid electrolyte layer 40. In other words, there is a second region, in which irregularities are not formed in the irregularity forming step, in the inside in a thickness direction of the solid electrolyte layer 40. This configuration makes it possible to improve the adhesion between the solid electrolyte layer 40 and the electrode layer, while maintaining the density of the solid electrolyte layer 40. Furthermore, for example, in comparison with a method of newly forming an electrolyte layer on the surface of the solid electrolyte layer 40 by application after the first pressing step, a work process can be simplified, and the manufacturing costs for the solid-state battery 1 can be reduced.

Forming the irregularities in the first region in the irregularity forming step allows the solid electrolyte layer 40 to be decrease in dynamic hardness. Thus, the adhesion can be improved when the solid electrolyte layer 40 and the electrode layer are integrated with each other in the second pressing step. The dynamic hardness is an index for use to evaluate hardness of a thin film, and can be measured using a micro-Vickers hardness tester (for example, using a diamond triangular pyramidal indenter as an indenter). It is preferable that the irregularity forming step makes the solid electrolyte layer 40 have dynamic hardness of 10 or less in at least a part thereof.

A diameter of the irregularities (projections and depressions) formed by the irregularity forming step is preferably 10 μm to 22 μm. Further, a distribution of the irregularities formed by the irregularity forming step is preferably 500 points/mm² to 3000 points/mm².

The irregularity forming step is preferably a step of continuously forming irregularities on the surface of the solid electrolyte layer 40 using a roll with a surface having irregularities. Thus, productivity of the solid-state battery 1 can be improved. The roll may include a plurality of rolls, and may form irregularities on the surface of the solid electrolyte layer 40 in multiple stages.

### Second Pressing Step

The second pressing step is a step of pressing the solid electrolyte layer 40 and at least one electrode layer selected from the negative electrode layer 20 and the positive electrode layer 30 that have been subjected to the first pressing step and the irregularity forming step, thereby integrating the layers with each other to thereby produce a laminate. It is preferable that in the second pressing step, the solid electrolyte layer 40 and the electrode layer are pressed while projections on the surface of the solid electrolyte layer 40 subjected to the irregularity forming step are crushed. Thus, the electrode layer is firmly pressure-bonded to the solid electrolyte layer 40 having the irregularities formed thereon.

Specific methods of pressing in the second pressing step are not particularly limited as in the first pressing step, and may include uniaxial pressing and roll pressing, for example. Pressing conditions can be set to, for example, 25° C. and 6 ton/cm² to 10 ton/cm².

### Manufacturing Apparatus for Solid-State Battery

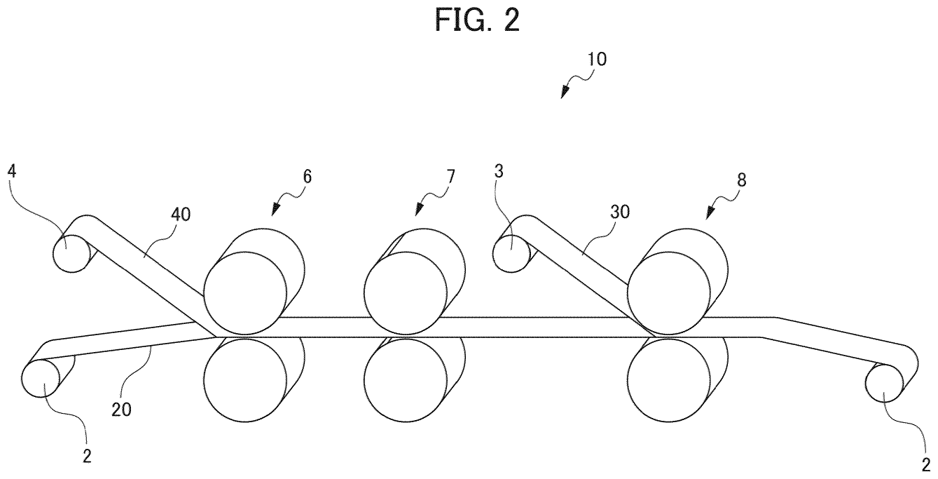

A manufacturing apparatus 10 for a solid-state battery according to the present embodiment to be described below is an example of a manufacturing apparatus capable of performing the manufacturing method for a solid-state battery described above. As shown in FIG. 2, the manufacturing apparatus 10 for a solid-state battery includes a first presser 6, an irregularity former 7, and a second presser 8.

### First Presser

The first presser 6 is configured to execute the first pressing step, and to press a layer including at least solid electrolyte layer 40. In FIG. 2, the first presser 6 is a roll press machine that laminates and presses the sheet-like solid electrolyte layer 40 fed from a winding body 4 and the negative electrode layer 20 fed from a winding body 2. The first presser 6 is not limited to the roll press machine described above, and may be a uniaxial press machine, a presser configured to press a sheet-like body including the solid electrolyte layer 40 formed on the negative electrode layer 20 or the positive electrode layer 30, or a presser configured to press only the sheet-like solid electrolyte layer 40.

### Irregularity Former

The irregularity former 7 is configured to execute the irregularity forming step, and to form irregularities on the surface of the solid electrolyte layer 40 pressed by the first presser. The irregularity former 7 is provided after the first presser 6. In FIG. 2, the irregularity former 7 is configured to form irregularities on one exposed side of the laminated surface of the solid electrolyte layer 40. In a case where the first presser 6 is configured to press only the sheet-like solid electrolyte layer 40, the irregularity former 7 may be configured to form irregularities both sides of the laminated surface of the solid electrolyte layer 40. In FIG. 2, the irregularity former 7 is configured as a single press machine, but is not limited thereto. The irregularity former 7 may be constituted by a plurality of press machines provided in multiple stages.

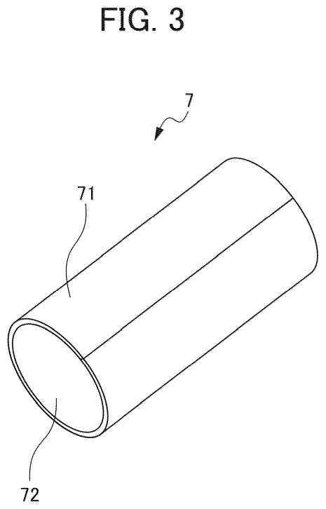

The irregularity former 7 is, for example, a press machine having projections at a contact portion that comes into contact with the solid electrolyte layer 40 and configured to form irregularities on the surface of the solid electrolyte layer 40 by means of the projections. For example, as shown in FIG. 3, the press machine includes a sheet-like body 71 having projections on its surface and wound around a cylindrical body 72. Alternatively, the press machine may include a metal roll having a surface on which irregularities are formed by sandblasting. Nevertheless, since sheet-like body 71 is detachably wound around the cylindrical body 72, the replacement can be easily performed, and easiness of maintenance of the manufacturing apparatus 10 for a solid-state battery can be improved.

The press machine as the irregularity former 7 preferably includes sandpaper as the sheet-like body 71 having the surface with projections. The sandpaper is available at a low cost, and with a preset grit, can form irregularities having desired intervals and sizes on the surface of the solid electrolyte layer 40. For example, it is preferable to use sandpaper within the range from grit *800 to grit *2000.

In the press machine as the irregularity former 7, a material forming the cylindrical body 72, around which the sheet-like body 71 is wound, is not particularly limited as long as having optimum hardness, but the material is preferably a ceramic-based material or a metal-based material. As such a cylindrical body 72, for example, a zirconia (ZrO₂) tube is preferably used. This is because the zirconia tube has optimum hardness when sandpaper is wound to form irregularities on the surface of the solid electrolyte layer 40. Zirconia (ZrO₂) has bending strength of 600 MPa to 1400 MPa, compressive strength of 3500 MPa to 5600 MPa, and Vickers hardness of 1250 HV to 1300 HV.

The second presser 8 is configured to execute the second pressing step. In FIG. 2, the second presser 8 is a roll press machine that laminates and presses the laminate of the solid electrolyte layer 40 having the irregularities formed on the surface by the irregularity former 7 and the negative electrode layer 20, and the positive electrode layer 30 fed from the winding body 3. The second presser 8 is not limited to the roll press machine described above, and may be a uniaxial press machine or a machine configured to laminate and press the negative electrode layer 20 and the positive electrode layer 30 onto the solid electrolyte layer 40 having irregularities formed on both surfaces. The laminate produced by the second presser 8 is wound around the winding body 9.

### Second Embodiment

Hereinafter, a manufacturing method and a manufacturing apparatus for a solid-state battery according to a second embodiment of the present invention will be described. A description of the same configuration as that of the first embodiment may be omitted.

### Manufacturing Method for Solid-State Battery

The manufacturing method for a solid-state battery according to the present embodiment includes a densification/irregularity-forming pressing step and a second pressing step. The manufacturing method for a solid-state battery according to the present embodiment is the same as the manufacturing method for a solid-state battery according to the first embodiment except that the densification/irregularity-forming pressing step is included instead of the first pressing step and the irregularity forming step.

### Densification/Irregularity-Forming Pressing Step

The densification/irregularity-forming pressing step is a step of pressing a layer including at least the solid electrolyte layer and forming irregularities on the surface of the solid electrolyte layer. The densification/irregularity-forming pressing step is one step of executing the first pressing step and the irregularity forming step according to the first embodiment.

The densification/irregularity-forming pressing step is, for example, a step of densifying and integrating the solid electrolyte layer 40 and one selected from the negative electrode layer 20 and the positive electrode layer 30 with each other by pressing, and forming irregularities on an exposed side of the laminated surface of the solid electrolyte layer 40. Alternatively, the densification/irregularity-forming pressing step may be a step of pressing only the sheet-like solid electrolyte layer 40 to densify the layer 40 and forming irregularities on both sides of the laminated surface of the solid electrolyte layer 40.

The densification/irregularity-forming pressing step preferably, for example, a step of continuously forming irregularities on the surface of the solid electrolyte layer 40 using a roll with a surface having irregularities formed thereon. The roll may include a plurality of rolls, and may form irregularities on the surface of the solid electrolyte layer 40 in multiple stages. As a preferable configuration in which the irregularities are formed on the surface of the solid electrolyte layer 40 in the densification/irregularity-forming pressing step, the same configuration as the irregularity forming step can be applied. A pressing pressure in the densification/irregularity-forming pressing step can be set to be higher than a pressing pressure in the irregularity forming step.

### Manufacturing Apparatus for Solid-State Battery

A manufacturing apparatus for a solid-state battery according to the present embodiment includes a densification/irregularity-forming presser and a second presser. The manufacturing apparatus for a solid-state battery according to the present embodiment is the same as the manufacturing apparatus for a solid-state battery according to the first embodiment, except that the densification/irregularity-forming presser is provided instead of the first presser and the irregularity former.

### Densification/Irregularity-Forming Presser

The densification/irregularity-forming presser is configured to press a layer including at least the solid electrolyte layer and form irregularities on the surface of the solid electrolyte layer. The densification/irregularity-forming presser is configured to execute, as one step, the steps that are performed by the first presser and the irregularity former according to the first embodiment.

The densification/irregularity-forming presser is configured to execute the densification/irregularity-forming pressing step. As a preferable configuration in which the irregularities are formed on the surface of the solid electrolyte layer 40 by the densification/irregularity-forming presser, the same configuration as the irregularity former can be applied.

In the foregoing, preferred embodiments of the present invention have been described. The present invention is not limited to the above-described embodiments, and can be modified as appropriate without departing from the spirit of the present invention.

### EXAMPLES

The present invention will be described in more detail below based on Examples, but the present invention is not limited to the following Examples.

### Manufacture of Laminate

### Example 1

Each of a positive electrode layer prepared by applying slurry including a positive electrode active material to a positive electrode current collector and a solid electrolyte layer prepared by applying solid electrolyte slurry was processed to have a diameter of 10 mm. Next, each of the positive electrode layer and the solid electrolyte layer was pre-pressed under conditions of 25° C. and 6 ton/cm² (corresponding to the first pressing step). Next, a roller prepared by winding sandpaper (grit *800) around a zirconia tube was manually rolled on the solid electrolyte layer (load of about 2 kg, 30 times) to form irregularities on the surface (corresponding to the irregularity forming step). The formed irregularities had a diameter of 21.8 μm and a distribution of 592 points/mm². Next, the surface of the solid electrolyte layer having the irregularities and the positive electrode layer were superimposed on each other and were integrally pressed under conditions of 25° C. and 6 ton/cm² (corresponding to the second pressing step), whereby a laminate according to Example 1 was obtained.

### Examples 2 and 3

Laminates according to Examples 2 and 3 were each obtained in the same manner as in Example 1, except that sandpaper of a different grit as shown in Table 1 (Example 2: grit *1000, Example 3: grit *2000) was used to form irregularities on the surface of the solid electrolyte layer, and the irregularities had a diameter and a distribution shown in Table 1.

### Comparative Example 1

A laminate according to Comparative Example 1 was obtained in the same manner as in Example 1, except that the pre-pressing step and the step of forming irregularities on the surface of the solid electrolyte layer were not performed.

### Comparative Example 2

A laminate according to Comparative Example 2 was obtained in the same manner as in Example 1, except that the step of forming irregularities on the surface of the solid electrolyte layer was not performed.

### Observation of Cross-Section

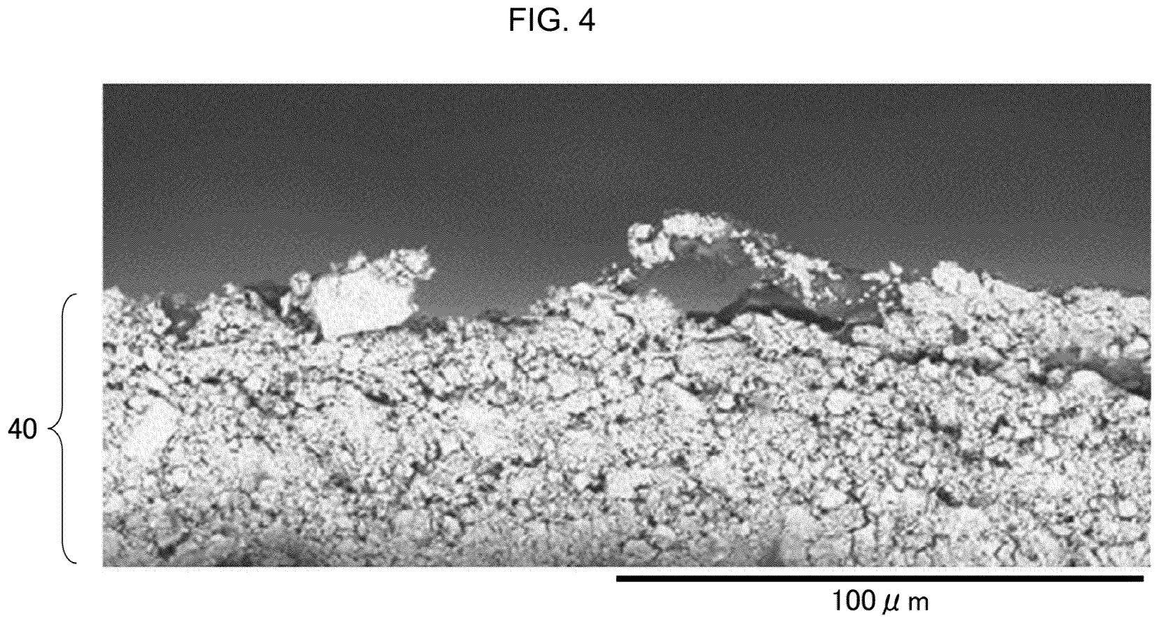

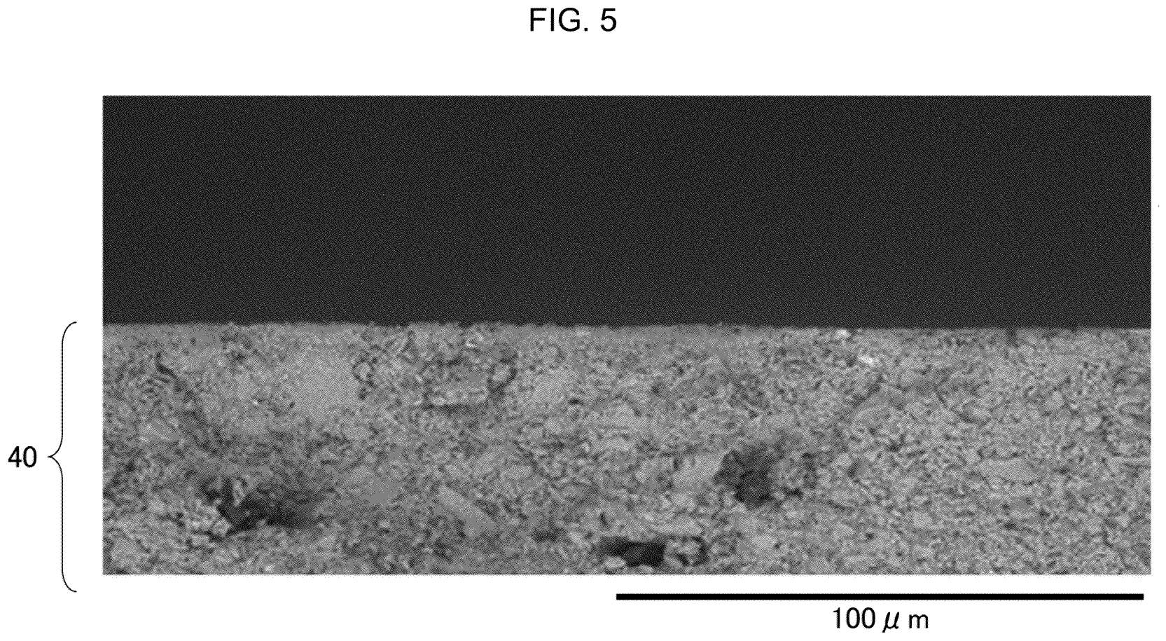

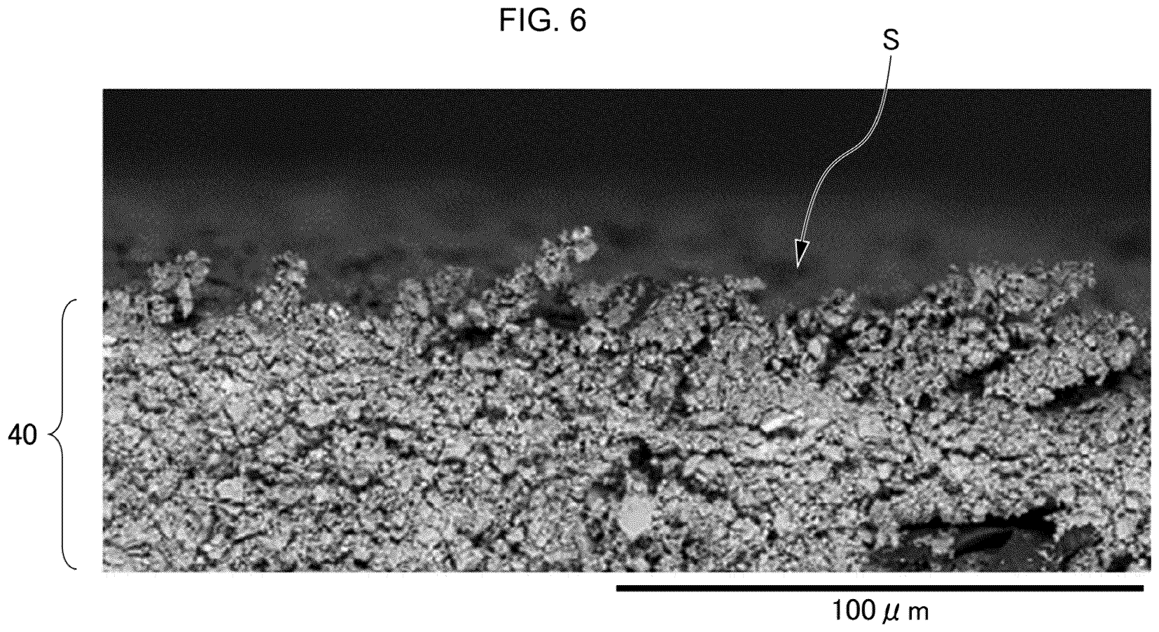

With a SEM (Miniscope (registered trademark) TM3000, produced by Hitachi High-Tech Corporation), an observation was performed on a cross-section near the surface of each of the solid electrolyte layers according to Example 1 and Comparative Examples 1 and 2 before being pressed integrally with the positive electrode layer. FIG. 4 is an SEM image obtained by photographing the cross-section near the surface of the solid electrolyte layer according to Comparative Example 1, FIG. 5 is an SEM image obtained by photographing the cross-section near the surface subjected to the pre-pressing step according to Comparative Example 2, and FIG. 6 is an SEM image obtained by photographing the cross-section near the surface having the irregularities formed after the pre-pressing step according to Example 1. The solid electrolyte of Example 1 has a density of 2.51 g/cm³, the solid electrolyte of Comparative Example 1 has a density of 1.72 g/cm³, the solid electrolyte of Comparative Example 2 had a density of 2.67 g/cm³. Thus, the density of the solid electrolyte of Comparative Example 1 in which the pre-pressing step was not performed was lower than the densities of the solid electrolytes of Example 1 and Comparative Example 2.

As shown in FIG. 6, it was confirmed that the surface S of the solid electrolyte layer according to Example 1 had the irregularities as in Comparative Example 1 before the pre-pressing step. On the other hand, according to Comparative Example 2 in which only the pre-pressing step was performed, the surface of the solid electrolyte layer was flat in comparison with that of Example 1 or Comparative Example 1.

### Tensile Test

A sample for tensile test (bonding area: 1×2 cm) was prepared based on the laminates according to Examples and Comparative Examples described above. One side of the laminated surface of the sample was attached to an SUS plate with double-sided tape, copper foil was attached to the other side, and the SUS plate in an erected state was fixed to a measurement stand (IMADA ZTA-2N, produced by IMADA Co., Ltd.). The copper foil fixed to a force gauge (IMADA MX2-500N, produced by IMADA Co., Ltd.) was pulled at a speed of 100 mm/min in a direction orthogonal to the laminated surface of the laminate. A strength at the moment when the sample ruptured or delaminated was measured, and a state after the test was observed. The results are shown in Table 1.

TABLE 1

| | | | | | Comparative | Comparative |
|---|---|---|---|---|---|---|
| | | Example 1 | Example 2 | Example 3 | Example 1 | Example 2 |
| Pre-Pressing | | 25° C., | 25° C., | 25° C., | — | 25° C., |
| (First Pressing Step) | | 6 ton/cm² | 6 ton/cm² | 6 ton/cm² | | 6 ton/cm² |
| Formation of | Diameter of | 21.8 | 18.3 | 10.3 | — | — |
| Irregularities | Projections and | | | | | |
| | Depressions (μm) | | | | | |
| | Distribution of | 592 | 1058 | 2525 | — | — |
| | Projections and | | | | | |
| | Depressions | | | | | |
| | (Point/mm²) | | | | | |
| | Grit | #800 | #1000 | #2000 | — | — |

| | | | | | |
|---|---|---|---|---|---|
| Integral Pressing | 25° C., | 25° C., | 25° C., | 25° C., | 25° C., |
| (Second Pressing Step) | 6 ton/cm² | 6 ton/cm² | 6 ton/cm² | 6 ton/cm² | 6 ton/cm² |
| Tensile Strength (N/m) | 1200 | 1000 | 1500 | 1000 | 200 |
| State after Test | Rupture | Rupture | Rupture | Rupture of | Interface |
| | of Base | of Base | of Base | Base | Delamination |
| | Material | Material | Material | Material | |

“Rupture of Base Material” shown in Table 1 indicates that portions other than the interface between the positive electrode layer and the solid electrolyte layer ruptured in the tensile test, and “Interface Delamination” indicates that delamination occurred at the interface between the positive electrode layer and the solid electrolyte layer in the tensile test.

From the results in Table 1, it was confirmed that the sample according to each of Examples did not experience delamination at the interface in the tensile test even though Examples were subjected to the pre-pressing step and that sufficient adhesion was obtained between the solid electrolyte layer and the electrode layer. In contrast, it was confirmed, from the results in Comparative Example 2 in which only the pre-pressing step was performed, that delamination occurred at the interface, the tensile strength was low, and sufficient adhesion was not obtained between the solid electrolyte layer and the electrode layer.

### EXPLANATION OF REFERENCE NUMERALS

1: solid-state battery

10: manufacturing apparatus for solid-state battery

20: negative electrode layer (electrode layer)

30: positive electrode layer (electrode layer)

40: solid electrolyte layer

6: first presser

7: irregularity former (press machine)

71: sheet-like body (sandpaper)

72: cylindrical body (zirconia tube)

8: second presser

What is claimed is:

1. A manufacturing method for a solid-state battery including an electrode layer composed of a positive electrode layer and a negative electrode layer, and a solid electrolyte layer, the method comprising:
a first pressing step of pressing a layer including at least the solid electrolyte layer;
an irregularity forming step of forming irregularities on a surface of the solid electrolyte layer; and
a second pressing step of pressing the solid electrolyte layer and the electrode layer to thereby produce a laminate.

2. A manufacturing method for a solid-state battery including an electrode layer composed of a positive electrode layer and a negative electrode layer, and a solid electrolyte layer, the method comprising:
a densification/irregularity-forming pressing step of pressing a layer including at least the solid electrolyte layer and forming irregularities on a surface of the solid electrolyte layer; and
a second pressing step of pressing the solid electrolyte layer and the electrode layer to thereby produce a laminate.

3. The manufacturing method for a solid-state battery according to claim 1, wherein
the forming of the irregularities on the surface of the solid electrolyte layer is performed by a press machine having projections on a contact portion that comes into contact with the solid electrolyte layer and configured to form the irregularities on the surface of the solid electrolyte layer using the projections of the contact portion.

4. The manufacturing method for a solid-state battery according to claim 3, wherein
the contact portion of the press machine is a sheet-like body having a surface with projections formed thereon, and
the sheet-like body is used by being wound around a cylindrical body.

5. The manufacturing method for a solid-state battery according to claim 4, wherein
the sheet-like body is detachably provided on the cylindrical body.

6. The manufacturing method for a solid-state battery according to claim 4, wherein
the sheet-like body is sandpaper.

7. The manufacturing method for a solid-state battery according to claim 4, wherein
the cylindrical body is a zirconia tube.

8. The manufacturing method for a solid-state battery according to claim 3, wherein
the forming of the irregularities on the surface of the solid electrolyte layer includes continuously forming the irregularities by a roll having a surface with irregularities.

9. The manufacturing method for a solid-state battery according to claim 3, wherein
the forming of the irregularities on the surface of the solid electrolyte layer includes continuously forming the irregularities in multiple stages by a plurality of rolls having surfaces with irregularities.

10. The manufacturing method for a solid-state battery according to claim 1, wherein
the solid electrolyte layer includes a first region having a predetermined thickness inward from the surface of the solid electrolyte layer and a second region located further inside the solid electrolyte layer than the first region, and
the forming of the irregularities on the surface of the solid electrolyte layer includes forming the irregularities only in the first region.

11. A manufacturing apparatus for a solid-state battery including an electrode layer composed of a positive electrode layer and a negative electrode layer, and a solid electrolyte layer, the apparatus comprising:
a first presser configured to press a layer including at least the solid electrolyte layer;
an irregularity former configured to form irregularities on a surface of the solid electrolyte layer; and
a second presser configured to press the solid electrolyte layer and the electrode layer to thereby produce a laminate.

12. A manufacturing apparatus for a solid-state battery including an electrode layer composed of a positive electrode layer and a negative electrode layer, and a solid electrolyte layer, the apparatus comprising:
a densification/irregularity-forming presser configured to press a layer including at least the solid electrolyte layer and form irregularities on a surface of the solid electrolyte layer; and
a second presser configured to press the solid electrolyte layer and the electrode layer to thereby produce a laminate.

13. The manufacturing apparatus for a solid-state battery according to claim 11, wherein
the irregularity former configured to form the irregularities on the surface of the solid electrolyte layer is a former configured to continuously form the irregularities using a cylindrical body having sandpaper wound therearound.

14. The manufacturing apparatus for a solid-state battery according to claim 11, wherein
the irregularity former configured to form the irregularities on the surface of the solid electrolyte layer is a former configured to continuously form the irregularities using a metal roll having a surface subjected to sandblasting.

15. The manufacturing apparatus for a solid-state battery according to claim 11, wherein
the irregularity former configured to form the irregularities on the surface of the solid electrolyte layer is a former configured to continuously form the irregularities using rolls disposed in multiple stages, the rolls having surfaces with irregularities.

16. The manufacturing apparatus for a solid-state battery according to claim 11, wherein
the irregularity former configured to form the irregularities on the surface of the solid electrolyte layer forms projections on the surface of the solid electrolyte layer, and
the second presser is configured to press the solid electrolyte layer and the electrode layer while crushing the projections to thereby produce a laminate.
